(19) United States
(12) Patent Application Publication
(10) Pub. No.: US 2004/0231371 A1
(43) Pub. Date: Nov. 25, 2004

(54) Method for providing non-aqueous laundering capability

(75) Inventors: William Michael Scheper, Guilford, IN (US); Richard Timothy Hartshorn, Lawrenceburg, IN (US); Christiaan Arthur Jacques Kamiel Thoen, West Chester, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/876,124

(22) Filed: Jun. 24, 2004

Related U.S. Application Data
(63) Continuation-in-part of application No. 10/738,551, filed on Dec. 17, 2003.
Application No. 10/738,551 is a continuation of application No. 09/849,893, filed on May 4, 2001, now Pat. No. 6,691,536.
(60) Provisional application No. 60/482,951, filed on Jun. 27, 2003.
(60) Provisional application No. 60/209,468, filed on Jun. 5, 2000.

(51) Int. Cl. B08B 3/12

(52) U.S. Cl. 68/3 R

(57) ABSTRACT

Disclosed is a method for providing non-aqueous laundering capability comprising: a) providing a non-aqueous laundering apparatus; b) installing the non-aqueous laundering apparatus; and/or c) servicing the non-aqueous laundering apparatus.

### CROSS REFERENCE TO RELATED APPLICATIONS

This application claims the benefit of U.S. Provisional Application Serial No. 60/482,951, filed on Jun. 27, 2003; and is a continuation-in-part of copending U.S. application Ser. No. 10/738,551, filed on Dec. 17, 2003, which is a continuation of U.S. of U.S. application Ser. No. 09/849,893, filed on May 4, 2001, now U.S. Pat. No. 6,691,536; which claims the benefit of U.S. Provisional Application Serial No. 60/209,468 filed on Jun. 5, 2000.

### FIELD

The present invention relates to a method for providing non-aqueous laundering capability to the domestic user.

### BACKGROUND

For centuries, fabric articles have been washed using water-based processes. In the last century, this chore was greatly simplified by the development of the automatic washing machine. However, while greatly simplifying the laundry process, even the home laundry process using the automatic washing machine still requires a significant amount of presorting fabric articles by color and textiles. Typically whites are washed separately from colored fabric articles, and brightly colored fabric articles (e.g., dark reds and blues) from less highly colored articles. Further sorting and handling is required when the fabric articles to be laundered include “dry clean only” articles.

More recently, water conservation efforts and environmental concerns have driven laundry machine manufacturers and laundry detergent manufacturers to reduce the amount of water required in the home laundry process. However, such efforts have focused on reducing water consumption by the wash medium rather than changing the wash medium from a primarily water based process.

In parallel, concerns have arisen around the use of “Perc” (short for perchloroethylene) as the wash medium for the commercial dry cleaning process. These concerns have lead to the development of a significant number of proposed alternatives to the Perc-based processes, but to date, all other alternatives are still not widely used. Examples of these alternatives include hydrocarbons and liquid carbon dioxide based laundering processes. A more recently proposed option as a replacement for Perc in the commercial dry cleaning field involves the use of siloxanes as the cleaning solution for “dry clean only” fabric articles (see, for example, U.S. Pat. Nos.: 5,942,007, Aug. 24, 1999; U.S. Pat. No. 6,042,617 and U.S. Pat. No. 6,042,618, both Mar. 28, 2000; U.S. Pat. Nos. 6,056,789, May 2, 2000; U.S. Pat. Nos. 6,059,845, May 9, 2000; and U.S. Pat. Nos. 6,063,135, May 16, 2000).

It has been discovered by the present invention that further simplification of the laundry process and elimination of the reliance on a solely water based home laundry process are possible by using a lipophilic based wash medium for the laundry process. When employed, e.g., in the home or at a self-serve laundromat, this process allows not only the personal cleaning of a user's dry clean only fabric articles, but also those “machine wash” articles conventionally washed in a water wash medium. Further, while the user may still opt to wash such articles separately, the present invention process allows the user the freedom to significantly simplify the laundry process by washing mixed loads of “dry clean only” and “machine wash” articles, thereby greatly reducing the presorting effort.

Existing non-aqueous laundering apparatuses are designed for commercial dry cleaning operation, therefore, these apparatuses are too bulky to be accommodated easily into a typical domestic residence. Scaling down of the commercial apparatuses is difficult because of the distillation unit and other components are designed to handle large scale operations. Therefore, it is desirable to have a non-aqueous laundering apparatus designed with suitable smaller components that can be delivered, in whole or in parts, to a domestic residence without difficulty.

Furthermore, components may break down or get consumed due to usage, thus, repairs and/or replacement of the components would become part of the routine maintenance. Additionally, as improvements to the components' functions and/or designs are made, it is desirable to be able to incorporate the upgrades without having to purchase an entirely new apparatus. Therefore, it is desirable to have the in-home non-aqueous laundering apparatus comprised of easily replaceable and/or upgradable components, which have suitably small size for an in-home laundering apparatus.

### SUMMARY

In one aspect of the present invention, it relates to a method for providing non-aqueous laundering capability comprising: (a) providing a non-aqueous laundering apparatus; (b) installing the non-aqueous laundering apparatus; and/or (c) servicing the non-aqueous laundering apparatus. In another aspect of the invention, it relates to a method providing non-aqueous laundering capability comprising: (a) installing the non-aqueous laundering apparatus; and (b) servicing the non-aqueous laundering apparatus.

### BRIEF DESCRIPTION OF THE DRAWINGS

While the specification concludes with claims which particularly point out and distinctly claim the invention, it is believed certain aspects of the present invention will be better understood from the following description of preferred embodiments taken in conjunction with the accompanying drawings, in which like numerals indicate the same elements throughout the views and wherein numerals having the same last two digits (e.g., 20 and 120) connote similar or corresponding elements; and in which:

FIG. 1 is a schematic view of a non-aqueous laundering apparatus for use in the present invention;

FIG. 2 is a cut away side view of a non-aqueous laundering apparatus for use in the present invention.

### DETAILED DESCRIPTION

All ratios are weight ratios unless specifically stated otherwise.

Except as otherwise noted, all amounts including quantities, percentages, portions, and proportions, are understood to be modified by the word “about”, and amounts are not intended to indicate significant digits.

Except as otherwise noted, the articles “a”, “an”, and “the” mean “one or more”.

Herein, “and/or” means subject X or subject Y or both.

Herein, “automatic home laundry process” means the laundry process as practiced by the user using an automatic washing machine, preferably located within the user's residence (herein referred to as the process being conducted “in the home”), but also including public laundromats whereby the user follows essentially the same laundry process as though the automatic washing machine were present in the home.

Herein, “comprising” means that other steps and other ingredients which do not affect the end result can be added. This term encompasses the terms “consisting of” and “consisting essentially of”. The compositions and methods/processes of the present invention can comprise, consist of, and consist essentially of the essential elements and limitations of the invention described herein, as well as any of the additional or optional ingredients, components, steps, or limitations described herein.

Herein, “domestic user” means an individual using a non-aqueous laundering apparatus for purposes of laundering personal and/or family member and/or friends' fabric article(s).

Herein, “dry clean only fabric articles” means those fabric articles readily identified by the fabric industry and consumers as unsafe for laundering by a conventional aqueous automatic home laundry process, and instead requiring special handling with a conventional non-aqueous solvent such as Perc. Again, consumers are frequently helped in this identification of fabric articles by manufacturer's tags (hereinafter referred to as “care labels”) identifying the fabric article as “dry clean only” or some similar description.

Herein, “fabric article” means any article that is customarily cleaned in a conventional laundry process or in a dry cleaning process. As such the term encompasses articles of clothing, linen and drapery, clothing accessories, and floor coverings. The term also encompasses other items made in whole or in part of fabric, such as tote bags, furniture covers, tarpaulins and the like.

Herein, “professional user” means an individual or entity 1) using a non-aqueous laundering apparatus for purposes of laundering fabric article(s) as a paid-for service to another party, and/or 2) providing another party access (typically for a fee, as in the case of a laundromat) to a laundering apparatus for purposes of the other party laundering fabric article(s) in the apparatus.

Herein, “machine washable fabric articles” means those fabric articles readily identified by the fabric industry and users as safe for laundering by a conventional aqueous automatic home laundry process. Users are frequently helped in this identification of fabric articles by care labels identifying the fabric article as “machine washable” or some similar description.

Herein, “wash medium” means the liquid (including but not limited to, fluid(s) and/or solution(s) and/or solvent(s) and/or emulsion(s)) which is used to wet the fabric articles in the wash load during the automatic home laundry process.

An embodiment of the present invention relates to a method for providing non-aqueous laundering capability comprising one or more of the following steps: a) providing a non-aqueous laundering apparatus, b) installing the non-aqueous laundering apparatus, and servicing the non-aqueous laundering apparatus. Preferably, the method comprises two of these steps, more preferably all three steps.

A. Non-Aqueous Laundering

Herein, “non-aqueous-laundering” refers to a process of treating and/or cleaning fabric articles comprising contacting the fabric articles with a cleaning fluid comprising a lipophilic fluid and removing from the fabric articles a portion of the cleaning fluid.

Herein, “non-aqueous” refers to a cleaning fluid comprising a lipophilic fluid that is substantially free of water. The lipophilic fluid can be used alone or in combination with adjunct materials to provide appropriate cleaning of the consumer garments, while minimizing the typical garment damage caused by traditional aqueous (water) laundering. The method of the present invention is directed to providing a non-aqueous laundering capability to the domestic user comprising: a) providing a non-aqueous laundering apparatus; b) installing the non-aqueous laundering apparatus; and/or c) servicing the non-aqueous laundering apparatus.

In a separate embodiment, the automatic washing machine can be a “bimodal laundry machine”. Herein, “bimodal laundry machine” refers to a single piece of equipment that has the ability to function either as a traditional aqueous automatic washing machine, having an aqueous laundry cycle, or as a non-aqueous automatic washing machine based on either domestic or professional user input or based on an automated decision system.

The method of the present invention is directed to attaining improved fabric cleaning in a non-aqueous laundry regimen, and includes the steps of exposing the fabric article to a lipophilic fluid and exposing the fabric article to a specific fabric care active. Optionally but preferably, it may include the step of exposing the fabric article to a polar phase.

The polar phase may include water, alcohol, or mixtures thereof. If the polar phase does include water, it preferably comprises at least about 0.5% water by weight of a subject fabric article(s) and at most about 10% water by weight of a subject fabric article(s).

The lipophilic fluid may comprise a linear siloxane, a cyclic siloxane, or mixtures thereof. Preferably, the lipophilic fluid is selected from the group consisting of octamethylcyclotetrasiloxane, decamethylcyclopentasiloxane, dodecamethylcyclohexasiloxane, and mixtures thereof. Even more preferably, the lipophilic fluid comprises decamethylcyclopentasiloxane. Most preferably, the lipophilic fluid comprises decamethylcyclopentasiloxane and is substantially free of octamethylcyclotetrasiloxane. Due to the flash points of the aforementioned siloxanes, the method preferably occurs at less than about 80° C.

B. Providing a Non-Aqueous Laundering Apparatus

An embodiment of the present invention includes the step of providing a non-aqueous laundering apparatus (“NALA”). The NALA may be provided to a domestic user. Though NALA is designed to fit into a domestic residence, this is not meant to be limiting; a NALA can also be provided to a professional or commercial user (e.g., a laundromat operator). The NALA may be provided by selling or renting the NALA to the subject user.

When the NALA is being used by a domestic user for domestic purposes, the machine must be of sufficient dimensions to fit into the household. Thus, it is desirable that the NALA fit through standard door openings. In an alternative embodiment, the NALA is delivered in sections and assembled on site, wherein each section has dimensions that fit through standard door opening. The components of the NALA that can be made into separate sections include, but are not limited to, one or more detachable storage tanks for storing lipophilic fluid, cleaning materials, or mixtures thereof; a non-distillative recovery system comprising a recovery tank, one or more filters, or combinations thereof; a control system which may be a smart control system, a electromechanical control system, or both; an applicator; a fabric-containing chamber, an outer chamber and the drive mechanism for the chambers.

When assembled, the NALA preferably but not required to have a footprint equal to or less than the width and depth of the current footprint of the combination of an automatic washing machine and automatic clothes dryer. Thus, in one embodiment of the NALA, the overall dimensions of the NALA has a depth from about 68.5 cm to about 137 cm, wherein the higher range is sufficient to accommodate a dual mode apparatus (i.e., an apparatus that is capable of performing both the washer and the dryer functions); a width of about 76 cm; and a height from about 139.7 cm to about 297.4 cm. In another embodiment, each section of the NALA has dimensions equal to or less than the corresponding dimensions in the fully assembled NALA.

In addition, the NALA may be delivered free of lipophilic fluid to the installation site.

C. Installing a Non-Aqueous Laundering Apparatus

Another embodiment of the present invention includes the step of installing a NALA. The NALA may be installed in a commercial location (e.g., a commercial dry-cleaner, self-serve laundromat, common area in an apartment building, etc.) or in a domestic location (e.g., in a domestic user's house, apartment, mobile home, etc.). Installation may involve merely delivery and unpackaging of the NALA, for NALA's that do not require an external source of lipophilic fluid and/or adjunct material (e.g., the lipophilic fluid is self-contained in the NALA, and adjunct materials are also self-contained and/or may be added directly to the NALA by the user). Alternatively, installation may further include connecting the NALA to one or more of the following: a lipophilic fluid source, water source, impinging gas source, adjunct materials source, plumbing, drainage to outside the installation site, and ventilation to outside the installation site. In most cases, the NALA would be readily connected to a power source during installation, or by the user subsequent to installation.

In one embodiment, the NALA is delivered to the installation site without one or more of the following contained in the NALA: lipophilic fluid, impinging gas, and/or adjunct material(s). In such an embodiment, the installing step may further include addition of such fluid, gas and/or adjunct material(s) to the NALA at the installing site.

Installation may further include testing of the NALA by the installing party, to confirm that the NALA is in proper working order.

In another embodiment, installation may include providing the user with training materials (e.g., hard copy, video, or computer file instructions) on how to use the NALA. Alternatively, such training may be provided by the installer physically demonstrating to the user, how to operate the NALA.

In one embodiment of a “bimodal laundry machine” (defined below), the aqueous laundering cycle could be used for a traditional aqueous automatic home laundry process and the non-aqueous laundry process would be used for fabric articles with a care label that instructs the consumer to use a professional drycleaner to care for the fabric article. In this embodiment the user would have the flexibility to select the best cycle for the given cleaning task and launder all fabric articles in view of the care label.

Whether the NALA has the added capability to also run a traditional aqueous laundry cycle or only has the non-aqueous laundering cycle, the user will need to be trained how to operate the non-aqueous automatic washing machine to achieve optimal performance. This training comprises instruction on how to operate the non-aqueous automatic washing machine and also how to chose dryclean only fabric articles and/or machine washable fabric articles appropriate for non-aqueous/aqueous laundering. This may include, but is not limited to, instruction by the sales personnel at the point of purchase, training during installation, on-line web site training material, video training, instructions on the machine including an interactive touch panel display to guide the user through the process.

D. Servicing a Non-aqueous Laundering Apparatus

Another embodiment of the present invention includes the step of servicing a NALA. Over time, small amounts of lipophilic fluid may escape from the NALA through retention on the fabric articles cleaned in the NALA and/or mechanical parts may become worn. Additionally, the user may prefer the convenience of not having to ever add any adjunct materials to the NALA. Consequently, the servicing step may include addressing one or more of these needs.

Servicing may be performed at the installation site, or may involve removal of the NALA from its installation site to a separate servicing site for servicing.

In one embodiment, servicing includes checking all mechanical, electrical and/or chemical components of the NALA, and replacing and/or upgrading any such components in need of replacement/upgrade.

In another embodiment, servicing includes checking all sections of the NALA, repairing the sections, conducting routine maintenance of the sections, replacing the sections with new, identical sections, or with upgrades of the sections. The capability of upgrading sections of NALA without replacing the entire apparatus is an economically attractive feature. Applicators, distillation systems, storage tanks, control systems are examples of

In another embodiment, servicing includes replacing and/or replenishing any lipophilic fluid that may have been lost during use prior to servicing. Alternatively, servicing may include complete removal of the lipophilic fluid from the NALA and replacement with fresh lipophilic fluid. In another embodiment, the lipophilic fluid is removed and cleaned (i.e., any impurities, such as sebum, it may have picked up from use in the NALA are removed) at the servicing site by the service technician, and the refreshed lipophilic fluid is returned to the NALA. Where the servicing site is also the installation site (e.g., in a user's home), the servicing technician may bring a portable cleaning system for such cleaning of the lipophilic fluid.

Servicing may also include the adding and/or replacement of consumable materials (such as impinging gases and or adjunct cleaning materials) into the NALA. Servicing also include the replacing and/or rejuvenating of relatively durable materials (such as the filters). Some of these materials need to be serviced after one cycle, preferably more than one cycles, and other materials need to be service only after multiple cycles.

Servicing may further include replacing the NALA with the same model the user has been using or with an upgraded model.

Certain embodiments of the NALA may include the ability to clean and reuse the lipophilic fluid for more than one automatic laundry process. A preferred means for cleaning the lipophilic fluid for multiple uses is a replaceable filter. Such a filter should preferably include filter materials capable of removing and collecting at least the body soils removed from the fabric articles during the automatic home laundry process. Activated charcoal, silicas, molecular sieves, and/or hydrophobically modified papers are just some optional components of such filters. The attachment to the NALA is preferably by means such that the user can readily replace it at regular intervals. However, servicing could also include cleaning and/or replacement of such filters by a service technician.

Servicing may be provided on an as-needed bases. For example, a user may check the status of the consumable materials and/or the conditions of the serviceable components or be informed by the sensors in the apparatus and call a service center for service, including repairs and replacements. The apparatus may be a smart machine equipped with self diagnosis capability to indicate when service is needed, and may be linked to a service center such that service information can be transmitted and services called with out user intervention. Servicing may also be provided on a regular intervals, for examples, via a service and/or maintenance contract so that a service technician would perform regular inspection, maintenance and/or repair work. Servicing may be provided as a combination of the above.

E. Non-aqueous Laundering Apparatus (NALA)

The NALA useful in the present process includes a chamber capable of receiving a fabric article, cleaning materials (including, e.g., lipophilic fluid) that can be added to the chamber, and a means to remove the cleaning materials from the chamber. Suitable examples are discussed in WO 01/94675. Other suitable examples are discussed in EP 1 103 646; WO 02/08510; U.S. Pat. No. 5,940,988; U.S. Pat. No. 4,765,161; U.S. Pat. No. 5,652,194; and U.S. Pat. No. 6,346, 126.

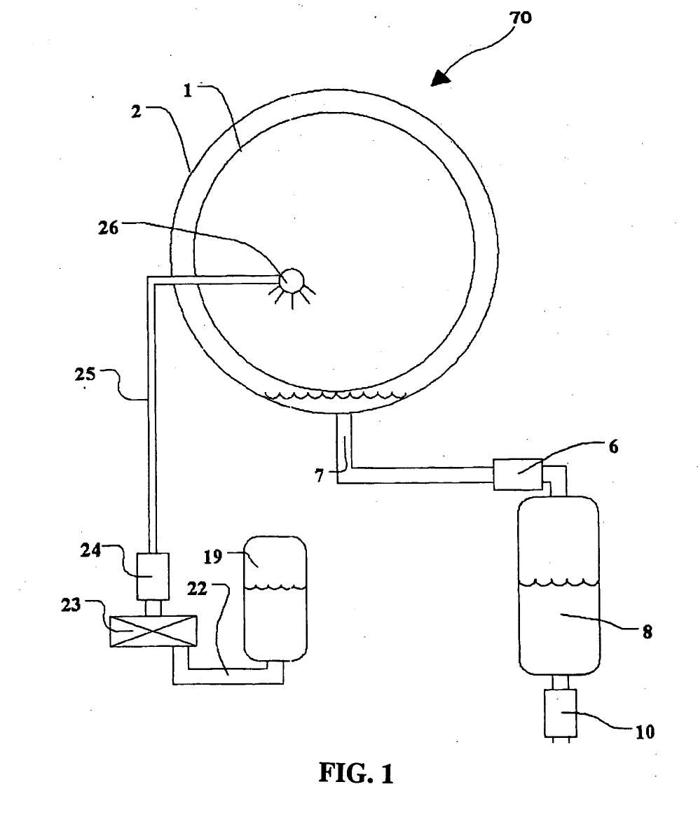

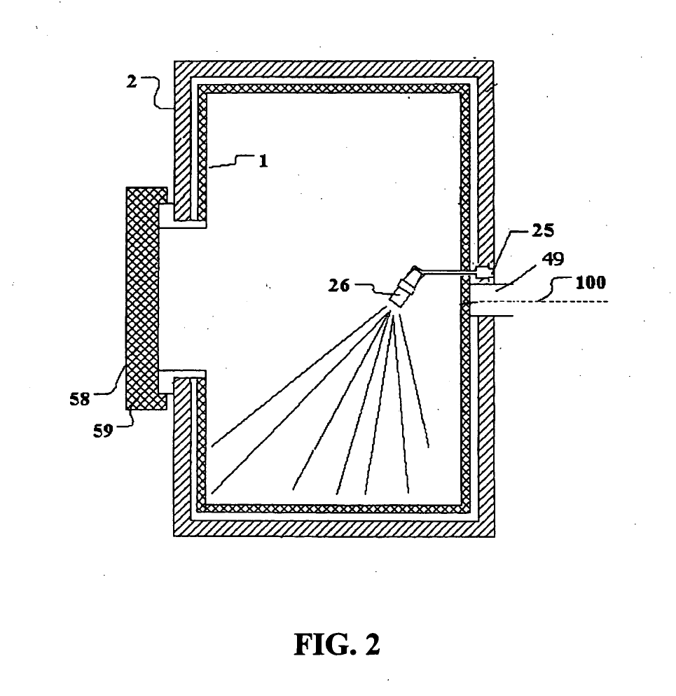

One preferred embodiment of the NALA system 70 is shown in FIG. 1, comprises a fabric-containing chamber 1 capable of receiving a fabric article to be treated and a cleaning material(s) (not shown, however discussed hereinbelow), wherein when a fabric article to be treated is present in the fabric-containing chamber 1, a cleaning material may be introduced into the fabric-containing chamber 1. The NALA 70, preferably further comprises an outer chamber 2 capable of receiving the cleaning material from the fabric-containing chamber 1 that is not retained in said fabric-containing chamber 1. The outer chamber 2 preferably houses the fabric-containing chamber 1. The fabric-containing chamber 1 and the outer chamber 2 preferably are of cylindrical construction and have a horizontal access opening 58 and 59, respectively, and, as shown in FIG. 2. The horizontal center line of the outer chamber 2, which is preferably stationary with respect to the fabric-containing chamber 1 coincides with the axis of rotation 100 of the movable fabric-containing chamber 1 movably mounted within the outer chamber 2. The outer chamber 2 preferably comprises an exit port or drain 7 through which the cleaning material received by the outer chamber 2 exits the outer chamber 2. The fabric-containing chamber 1 is preferably rotatably secured to outer chamber 2 by means of drive shaft 49 (FIG. 2). The cross-sectional views of FIG. 2, the outer chamber 2 may have a door 59 having a circular shape with an outer edge, the door 59 is capable of opening and closing and may be used to load and unload fabric articles from the NALA 70. The fabric-containing chamber 1 may have an access opening 58 used to load and unload fabric articles from the NALA 70; preferably, which is concentrically aligned with the outer edge of the door 59 in outer chamber 2. When the NALA 70 is in operation, the door 59 is in the closed position, preferably locked by a locking means (not shown) when the NALA 70 is in operation.

At least one large storage tank 19 may contain the cleaning material. In another embodiment the cleaning material may also be present in one large storage tank 20. This can eliminate the need for any mixing prior to delivery of the contents of the large storage tank, 19 or 20, to the fabric-containing chamber 1 via an applicator 26, preferably a spray nozzle. Alternatively, cleaning material from the large storage tank 19, may be mixed with other cleaning material (e.g., adjunct material), which may be stored in small storage tanks 27 and 28. These small storage tanks 27 and 28, preferably contain one or more cleaning materials which are intended to be applied onto the fabric article present in the fabric-containing chamber 1 of the NALA 70.

For the convenience of a user, the large storage tanks 19 and 20, and the small storage tanks 27 and 28 may optionally be detachable from the NALA 70. The storage tanks, 19, 20, 27 and 28, may then be recycled, or can be refilled and reattached to the apparatus. Alternatively, the storage tank, 19, 20, 27 and 28, may be replaceable or disposable, for example as a replaceable cartridge. In one suitable mode of operation, the large storage tanks 19 and 20 are recyclable, permanently fixed in the NALA 70, or removable only by a trained service technician, while the small storage tanks, 27 and 28, are user-replaceable cartridges which are sold individually or as part of a kit discussed hereinbelow.

In one mode, once the contents of the storage tanks, 19, 20, 27 and 28, are consumed, the empty storage tanks, 19, 20, 27 and 28, are removed and replaced with identical storage tanks, 19, 20, 27 and 28, containing the desired cleaning material or storage tanks, 19, 20, 27, and 28, differing in the cleaning material contained therein, so as to provide different benefits, e.g., cleaning benefits, antistatic benefits, home waterproofing, etc. In one embodiment, the storage tanks, 19, 20, 27, and 28, may be either disposed of by the user or returned for refilling by a third party, such as, a service technician, retailer, wholesaler, or a manufacturer, with the requisite amount of the desired cleaning material. Alternatively, only one of the large storage tanks 19 or 20 might be detachable, with the other large storage tank, 19 or 20, permanently attached to the NALA 70. Similarly, another possible alternative is that only one of the small storage tanks 27 or 28 is be detachable, with the other small storage tank, 28 or 29, permanently attached to the NALA 70. Any large storage tank, 19 and 20, or small storage tank 28, and 29, permanently affixed to the NALA 70 may have a closing means (not shown), such as a re-sealable lid.

The desired cleaning materials are delivered into the applicator 26 preferably by pumping with pump 24. The cleaning material stored in the large storage tanks 19 and 20 are pumped from through lines 22 and 21 respectively, first passing through valve 23, then through pump 24, then finally through line 25 to applicator 26.

Once the cleaning material enters the fabric article chamber 1, it is collected in the outer chamber 2. The cleaning material exits the outer chamber 2 by use of a drain 7 and then enters a recover tank 8. Prior to delivering cleaning materials into recovery tank 8, cleaning materials are filtered in filter 6. Preferably an air compressor (not shown) would be connected to each of the large storage tanks, 19 and 20, and small storage tanks, 27 and 28, by pressure lines. Other means of conveying cleaning materials may include gravity, centrifugal, diaphragm, piston, or peristaltic pumps.

Filter 6 removes lint, fabric fibers and large particulate soil, so they don't settle on the recovery tank 8 bottom and clog downstream lines. Also, filter 6 assures reliable operation of pump 10, since pump 10 is a typically higher pressure pump which generally is of a type more easily damaged by solids.

In a preferred embodiment, the NALA contains some type of control system. Such control systems include electrical systems, such as, the so-called smart control systems, as well as more traditional electromechanical systems. The control systems would enable the user to select the size of the load of fabric articles to be cleaned, the type of soiling, the extent of the soiling, the time for the cleaning cycle. Alternatively, the user could use pre-set cleaning and/or refreshing cycles, or the apparatus could control the length of the cycle, based on any number of ascertainable parameters. This would be especially true for electrical control systems. For example, when the collection rate of lipophilic fluid reaches a steady rate the apparatus could turn its self off after a fixed period of time, or initiate another process for the lipophilic fluid.

In the case of electrical control systems, one option is to make the control device a so-called “smart device”. This could mean including, but not limited to, self diagnostic system, load type and cycle selection, linking the machine to the Internet and allowing for the user to start the apparatus remotely, be informed when the apparatus has cleaned a fabric article, or for the supplier to remotely diagnose problems if the apparatus should break down. Furthermore, if the apparatus of the present invention is only a part of a cleaning system, the so called “smart system” could be communicating with the other cleaning devices which would be used to complete the remainder of the cleaning process, such as a washing machine, and a dryer.

Other examples of NALA useful in the present process include the following:

While an apparatus having the various components as defined for the immersive commercial dry cleaning process as described in U.S. Pat. No. 6,059,845, issued May 9, 2000, and U.S. Pat. No. 6,063,135, issued May 16, 2000, if modified for residential size and user maintenance, could be used to practice the present invention process, an immersive process for the present process is not preferred. Reasons include the constraints (versus the commercial dry cleaner size and operation taught in these patents) associated with supplying, storing and cleaning larger volumes of lipophilic fluids at the laundering site; particularly where the laundering site is in the home.

For these reasons apparatus for providing lower volume cleaning processes such as those utilizing a uniform spray process that completely wets the fabric articles with the lower volumes of wash medium as described herein before are highly preferred. For example modifications of conventional low water wash appliances to deliver low levels of lipophilic fluid containing wash medium rather than a water wash medium should be considered; such conventional water wash appliances are described for example in U.S. Pat. Nos.: 4,489,574; 4,489,455; 5,191,669; 5,191,668; 5,233,718; and 5,671,494. A more preferred automatic washing machine useful for such low volume cleaning is described in detail in U.S. patent application serial No. 60/209468 filed Jun. 5, 2000. Further preferred are laundering apparatus that guarantee homogeneous coverage of the fabric articles with the lipophilic fluid containing wash medium by intermittent spin and spray followed by random tumbling until all the wash medium has been sprayed. Also preferred are such apparatus which reuse the lipophilic fluid-containing wash medium via an immediate re-use/recycling action, for example by passing the wash medium over a particle removal filter after extraction from the fabric articles and then immediately spraying it back onto the fabric articles.

Further preferred laundering apparatus for use in the present process are designed to also dry the fabric articles in the same apparatus. This not only allows the user the convenience of not having to handle the wet fabric articles but also permits recovery of all the lipophilic fluid for reuse or cleaning.

In another embodiment, the NALA can be a “bimodal laundry machine”. Herein, “bimodal laundry machine” refers to a single piece of equipment that has the ability to function either as a traditional aqueous automatic washing machine, having an aqueous laundry cycle, or as a non-aqueous automatic washing machine based on either domestic or professional user input or based on an automated decision system.

F. Lipophilic Fluid

“Lipophilic fluid” as used herein means any liquid or mixture of liquid that is immiscible with water at up to 20% by weight of water. In general, a suitable lipophilic fluid can be fully liquid at ambient temperature and pressure, can be an easily melted solid, e.g., one that becomes liquid at temperatures in the range from about 0° C. to about 60° C., or can comprise a mixture of liquid and vapor phases at ambient temperatures and pressures, e.g., at 25° C. and 1 atm. pressure.

It is preferred that the lipophilic fluid herein be inflammable or, have relatively high flash points and/or low VOC characteristics, these terms having conventional meanings as used in the dry cleaning industry, to equal or, preferably, exceed the characteristics of known conventional dry cleaning fluids.

Non-limiting examples of suitable lipophilic fluid materials include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

“Siloxane” as used herein means silicone fluids that are non-polar and insoluble in water or lower alcohols. Linear siloxanes (see for example U.S. Pat. Nos. 5,443,747, and 5,977,040) and cyclic siloxanes are useful herein, including the cyclic siloxanes selected from the group consisting of octamethyl-cyclotetrasiloxane (tetramer), dodecamethyl-cyclohexasiloxane (hexamer), and preferably decamethyl-cyclopentasiloxane (pentamer, commonly referred to as “D5”). A preferred siloxane comprises more than about 50% cyclic siloxane pentamer, more preferably more than about 75% cyclic siloxane pentamer, most preferably at least about 90% of the cyclic siloxane pentamer. Also preferred for use herein are siloxanes that are a mixture of cyclic siloxanes having at least about 90% (preferably at least about 95%) pentamer and less than about 10% (preferably less than about 5%) tetramer and/or hexamer.

The lipophilic fluid can include any fraction of dry-cleaning solvents, especially newer types including fluorinated solvents, or perfluorinated amines. Some perfluorinated amines such as perfluorotributylamines, while unsuitable for use as lipophilic fluid, may be present as one of many possible adjuncts present in the lipophilic fluid-containing composition.

Other suitable lipophilic fluids include, but are not limited to, diol solvent systems e.g., higher diols such as C₆ or C₈ or higher diols, organosilicone solvents including both cyclic and acyclic types, and the like, and mixtures thereof.

Non-limiting examples of low volatility non-fluorinated organic solvents include for example OLEAN® and other polyol esters, or certain relatively nonvolatile biodegradable mid-chain branched petroleum fractions.

Non-limiting examples of glycol ethers include propylene glycol methyl ether, propylene glycol n-propyl ether, propylene glycol t-butyl ether, propylene glycol n-butyl ether, dipropylene glycol methyl ether, dipropylene glycol n-propyl ether, dipropylene glycol t-butyl ether, dipropylene glycol n-butyl ether, tripropylene glycol methyl ether, tripropylene glycol n-propyl ether, tripropylene glycol t-butyl ether, tripropylene glycol n-butyl ether.

Non-limiting examples of other silicone solvents, in addition to the siloxanes, are well known in the literature, see, for example, Kirk Othmer's Encyclopedia of Chemical Technology, and are available from a number of commercial sources, including GE Silicones, Toshiba Silicone, Bayer, and Dow Corning. For example, one suitable silicone solvent is SF-1528 available from GE Silicones.

Non-limiting examples of glycerine derivative solvents include materials having the following structure:

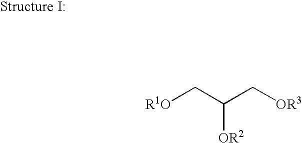

wherein R¹, R² and R³ are each independently selected from: H; branched or linear, substituted or unsubstituted C₁-C₃₀ alkyl, C₂-C₃₀ alkenyl, C₁-C₃₀ alkoxycarbonyl, C₃-C₃₀ alkyleneoxyalkyl, C₁-C₃₀ acyloxy, C₇-C₃₀ alkylenearyl; C₄-C₃₀ cycloalkyl; C₆-C₃₀ aryl; and mixtures thereof. Two or more of R¹, R² and R³ together can form a C₃-C₈ aromatic or non-aromatic, heterocyclic or non-heterocyclic ring.

Non-limiting examples of suitable glycerine derivative solvents include 2,3-bis(1,1-dimethylethoxy)-1-propanol; 2,3-dimethoxy-1-propanol; 3-methoxy-2-cyclopentoxy-1-propanol; 3-methoxy-1-cyclopentoxy-2-propanol; carbonic acid (2-hydroxy-1-methoxymethyl)ethyl ester methyl ester; glycerol carbonate and mixtures thereof.

Non-limiting examples of other environmentally-friendly solvents include lipophilic fluids that have an ozone formation potential of from about 0 to about 0.31, lipophilic fluids that have a vapor pressure of from about 0 to about 0.1 mm Hg, and/or lipophilic fluids that have a vapor pressure of greater than 0.1 mm Hg, but have an ozone formation potential of from about 0 to about 0.31. Non-limiting examples of such lipophilic fluids that have not previously been described above include carbonate solvents (i.e., methyl carbonates, ethyl carbonates, ethylene carbonates, propylene carbonates, glycerine carbonates) and/or succinate solvents (i.e., dimethyl succinates).

“Ozone Reactivity” as used herein is a measure of a VOC's ability to form ozone in the atmosphere. It is measured as grams of ozone formed per gram of volatile organics. A methodology to determine ozone reactivity is discussed further in W. P. L. Carter, “Development of Ozone Reactivity Scales of Volatile Organic Compounds”, Journal of the Air & Waste Management Association, Vol. 44, Pages 881-899, 1994. “Vapor Pressure” as used can be measured by techniques defined in Method 310 of the California Air Resources Board.

Preferably, the lipophilic fluid comprises more than 50% by weight of the lipophilic fluid of cyclopentasiloxanes, (“D5”) and/or linear analogs having approximately similar volatility, and optionally complemented by other silicone solvents.

G. Adjunct Materials

It is also envisioned that adjuncts for cleaning and/or treating the fabric articles according to the desires of the user may be included in the process of non-aqueous laundering. The NALA therefore preferably includes receptacles for receiving and/or dispensing such adjuncts into the non-aqueous laundering process at the desired time, either with the wash medium or separate from it. Cartridges containing such adjuncts (either through refilling or purchased with the adjunct) that releaseably attach to the machine are also optional executions. Suitable adjunct materials include, but are not limited to, abrasion inhibition agents, abrasives, alkalinity sources, antibacterial agents, anti-crocking agents, anti-fade agents, antimicrobial agents, anti-oxidants, anti-redeposition agents, antistatic agent, anti-tarnishing agents, bleach activators, bleach boosters, bleach catalysts, bleaches, brighteners, builders, chelants, colorants, color care agents, composition coloring agents, composition malodor control agents, corrosion inhibitors, crystal growth inhibitors, diamines or polyamines and/or their alkoxylates, divalent or trivalent ions, durable press agents, dye abrasion inhibitors, dye fixatives, electrolytes, enzymes, enzyme stabilizers, fabric softening agents, finishing aids, heavy metal ion sequestrants, hydrotropes, lime soap dispersants, metal ion salts, odor control agents, odor neutralizers, optical brighteners, perfumes, pH modifiers, photobleaches, polar solvents, process aids, pro-perfumes, polymeric dye transfer inhibiting agents, rebuild agents, softening agents, soil release polymers, soil suspending agents solvents, stabilizing polymers, suds or foam boosters, suds or foam suppressors, sunscreen agents, surfactants, thickeners, waterproofing agents, wrinkle reduction agents, wrinkle removal agents, wrinkle resistance agents, and mixtures thereof.

These adjunct materials can be applied either separately or as a result of being contained within the polar phase, the lipophilic fluid, and/or the specific fabric care active.

The fabric articles may also be exposed to an emulsifier and/or a surfactant either separately or as a result of being contained within the polar phase, the lipophilic fluid, and/or the bleach system.

When water is used as an adjunct material, it is used at less than 50% by weight of the solvent system, preferably less than 20% and most preferably between 0.5 and 10%.

H. Impinging Gas

In certain embodiments, the NALA contacts fabric articles with an impinging gas at any time during cleaning of the fabric articles in the NALA, as set forth in U.S. patent application publication No. 2002/0054202A1A1, published May 4, 2001; and U.S. patent application publication No. 2002/0133885A1, published Sep. 26, 2002.

It is desirable that the fabric articles are contacted by an impinging gas at least prior to applying the lipophilic fluid. The impinging gas facilitates the removal particulate soils from the fabric articles. Particulate soils can be successfully removed using gas flow. Particulate soils include any soil that is comprised of discrete particles. Nonlimiting examples of such particulate soils include clay, dust, dried mud, sand, cat fur, skin flakes or scales, dander, dandruff, hair from people or pets, grass seeds, pollen, burrs, and/or similar animal, mineral or vegetable matter which is insoluble in water.

By utilizing the impinging gas, “demand” on chemicals in the process for removing such particulate soils is reduced.

Preferably, the impinging gas is selected from the group consisting of air, nitrogen, ozone, oxygen, argon, helium, neon, xenon, and mixtures thereof; more preferably air, nitrogen, ozone, oxygen, argon, helium, and mixtures thereof; even more preferably still air, ozone, nitrogen, and mixtures thereof.

All documents cited in the Detailed Description are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for providing non-aqueous laundering capability comprising:
a. providing a non-aqueous laundering apparatus;
b. installing the non-aqueous laundering apparatus; and
c. optionally, servicing the non-aqueous laundering apparatus; wherein the non-aqueous laundering capability employs a lipophilic fluid in the laundering process.

2. The method of claim 1, wherein the non-aqueous laundering apparatus is provided to a user by selling, renting, or combination thereof.

3. The method of claim 1, wherein the non-aqueous laundering apparatus is installed in a domestic location.

4. The method of claim 1, wherein the non-aqueous laundering apparatus is installed in a commercial location.

5. The method of claim 1, wherein the non-aqueous laundering apparatus has dimensions smaller than or equal to 137 cm by 76 cm.

6. The method of claim 1, wherein the non-aqueous laundering apparatus is provided in two or more sections, each having dimension smaller than or equal to 137 cm by 76 cm.

7. The method of claim 1, wherein the sections are delivered as separate pieces and combined on site during installation.

8. The method of claim 1, wherein the non-aqueous laundering apparatus is a bimodal automatic washing machine.

9. The method of claim 8, wherein the non-aqueous laundering apparatus is provided in two or more sections, each having dimension smaller than or equal to 137 cm by 76 cm.

10. The method of claim 8, wherein the sections are delivered as separate pieces and combined on site during installation.

11. The method of claim 1, wherein the servicing step includes cleaning or replacing lipophilic fluid in the non-aqueous laundering apparatus.

12. The method of claim 1, wherein the servicing step includes replacing sections in the non-aqueous laundering apparatus with identical sections or upgrade sections.

13. The method of claim 12, wherein the section comprises:
(1) an applicator;
(2) one or more detachable storage tanks for storing lipophilic fluid, for storing cleaning materials, or for storing mixtures thereof;
(3) a non-distillative recovery system comprising a recovery tank, one or more filters, or combinations thereof;
(4) a control system comprising a smart control system, a electromechanical control system, or combinations thereof; or
(5) combinations thereof.

14. A method for providing non-aqueous laundering capability comprising:
a. installing the non-aqueous laundering apparatus; and
b. servicing the non-aqueous laundering apparatus.

15. The method of claim 14, wherein the servicing step includes cleaning or replacing lipophilic fluid in the non-aqueous laundering apparatus.

16. The method of claim 14, wherein the servicing step includes replacing sections in the non-aqueous laundering apparatus with identical sections or upgrade sections.

17. The method of claim 16, wherein the section comprises:
(1) an applicator;
(2) one or more detachable storage tanks for storing lipophilic fluid, for storing cleaning materials, or for storing mixtures thereof;
(3) a non-distillative recovery system comprising a recovery tank, one or more filters, or combinations thereof;
(4) a control system comprising a smart control system, a electromechanical control system, or combinations thereof; or
(5) combinations thereof.

18. The method of claim 14, wherein servicing is provided in regular intervals, as needed, or both.
